(19) United States
(12) Patent Application Publication
(10) Pub. No.: US 2015/0185156 A1
(43) Pub. Date: Jul. 2, 2015

(54) Dispersible Surface-Enhanced Raman Scattering Nanosheets

(71) Applicant: NORTHWESTERN UNIVERSITY, Evanston, IL (US)

(72) Inventors: Chad A. Mirkin, Wilmette, IL (US); Kyle D. Osberg, Chicago, IL (US); Matthew J. Rycenga, Chicago, IL (US); Gilles R. Bourret, Chicago, IL (US); Keith A. Brown, Evanston, IL (US)

(21) Appl. No.: 14/415,304

(22) PCT Filed: Jul. 30, 2013
(86) PCT No.: PCT/US13/52610

§ 371 Date: Jan. 16, 2015

Related U.S. Application Data
(60) Provisional application No. 61/677,810, filed on Jul. 31, 2012.

(51) Int. Cl. G01N 21/65; B42D 25/30

(52) U.S. Cl. CPC G01N 21/658; B42D 25/30

(57) ABSTRACT

Provided are nanosheets of SERS-active nanostructures embedded in the sheets and methods of using the same.

### STATEMENT OF U.S. GOVERNMENTAL INTERESTS

This invention was made with government support under grant number N00244-09-1-0012 awarded by the Department of Defense and grant number FA9550-09-1-0294 awarded by the Air Force Office of Scientific Research. The U.S. government has certain rights in the invention.

### BACKGROUND

Surface-enhanced Raman spectroscopy (SERS) is a potentially useful technique that underscores the importance of controlling the geometry of metal nanostructures. (1-7) Under optimal conditions, these structures can produce large enhancements in the Raman signal from molecules located near their surfaces compared to conventional Raman spectroscopy, which is useful for important applications such as detection. Much of the growth in understanding SERS can be attributed to an improved ability to rationally design and synthesize metal nanostructures that act as Raman enhancing ‘hot spots’, most commonly gold and silver nanoparticles spaced by small dielectric gaps (sub-5 nm). (5, 8-10) While these synthetic methods are predominantly surface-based, in recent years, researchers have begun controllably synthesizing solution-dispersible nanoparticle hot spots that can be dispensed onto an arbitrary surface to enable the trace detection of molecules present on that surface with SERS. (5, 10-12) There have been several initial demonstrations of this concept. (10, 13-15) However, many challenges emerge when attempting to use the nanostructures in this way. Most importantly, dispersing nanoparticles in such a way that the Raman hot spots are discrete and uniformly distributed on a surface can be challenging due to uncontrolled aggregation of the structures that adversely affects their SERS properties, particularly on topographically complex surfaces. Thus, a need exists for nanostructures capable of providing consistent SERS signals regardless of a surface's topography.

### SUMMARY

Disclosed herein are nanosheets comprising at least two SERS-active nanostructures and a support, wherein the support holds the at least two SERS-active nanostructures at a distance relative to each other. This immobilization of the SERS-active nanostructures allows for the maintenance of the SERS-signal that can be eroded by aggregation of the SERS-active nanostructures. Contemplated SERS-active nanostructures include nanorods, nanowires, triangular nanoprisms, and concave cubes. The SERS-active nanostructures comprise metals that are SERS-active, such as gold, silver, and copper. The density of the SERS-active nanostructure can be tailored to provide a SERS-signal sensitivity useful for a specific end use. The density can be about 5 nanostructures/μm² to about 100 nanostructures/μm². In some embodiments, the density can be about 5 nanostructures/μm² to about 50 nanostructures/μm²; about 10 nanostructures/μm² to about 40 nanostructures/μm²; about 5 nanostructures/μm² to about 20 nanostructures/μm²; or about 15 nanostructures/μm² to about 40 nanostructures/μm². The support of the nanosheets as disclosed herein can be a metal, a metal oxide, a polymer, an insulating material, or a semiconductor. A specific example contemplated is silica. The support can have a thickness of about 5 to about 100 nm, about 5 to about 75 nm, about 5 to about 50 nm, or about 5 to about 25 nm. The nanosheets can further comprise a dye or a SERS-active compound (e.g., a compound that has a SERS-signal upon irradiation). Some specifically contemplated SERS-active compounds include 4-methoxythiophenol, 4-bromothiophenol, 3-chlorothiophenol, 4-methylthiophenol, 3-methoxythiophenol, 4-aminothiopenol (APT), and 1,4-benzenedithiol (1-4,BDT).

The disclosed nanosheets can be affixed to a substrate. In some cases, the substrate is planar. In some cases, the substrate is non-planar, such as spherical, wavy, irregular, conical, corrugated, fibrous, rough, or porous. The substrate can be, e.g., a silica sphere, a silicon wafer, a plurality of cells, or a currency note.

Further disclosed herein are methods of making a nanosheet as described herein, comprising (a) dispersing at least two nanorods on an arbitrary support to form a dispersed nanorod assembly, each nanorod comprising at least two metal segments separated by a sacrificial metal segment; (b) introducing a support onto the dispersed nanorod assembly to form an intermediate assembly, wherein the support is different from the arbitrary support; (c) removing the arbitrary support from the intermediate assembly; and (d) removing the sacrificial metal segment to form the gap. In some cases, the dispersing of step (a) comprises dispersing the at least two nanorods in a solvent to form a nanorod dispersion and filtering the nanorod dispersion onto the arbitrary support. The filtration can be via vacuum filtration. In some cases, the dispersing of step (a) comprises patterning the arbitrary support with a binding affinity material compatible with the at least two nanorods using lithography.

Further provided herein are methods of detecting a SERS-active compound in a sample using the nanosheets as described herein. For example, the method can comprise, (a) contacting the sample with the nanosheet; (b) irradiating the nanosheet; and (c) detecting for the presence of a SERS signal, wherein the presence of the SERS signal indicates the presence of the SERS-active compound. Such methods can be useful for the detection for low concentrations (e.g., 1 pM to 1 μM, 10 pM to 100 nm) of illicit drugs that are SERS-active, such as cocaine, heroin, methadone, codeine, tetrahydrocannabinol (THC), or methamphetamine.

Also provided herein are methods of confirming the authenticity of a good, comprising affixing a nanosheet as described herein to a genuine good to identify the genuine good via a unique or known SERS signal; and analyzing a suspect good for the SERS signal from the nanosheet, wherein the absence of the SERS signal indicates that the good is counterfeit. The nanosheet can be affixed to the good itself, to a product label, a product package, or a product insert. In some cases, the good is a currency note.

### BRIEF DESCRIPTION OF THE FIGURES

FIG. 1 shows the structure of SERS nanosheets. (a) Scheme illustrating how the nanosheets (1-4 microns in size) conform to the topography of surfaces on which they are dispensed. The resulting geometry of the nanowires embedded in the sheets is maintained and controlled: gap size (g), metal segment length (s), and nanowire density (d). (b, c) STEM images of the nanowires in the nanosheets, showing their morphology and distribution across the silica. (d, e) SEM images of the sheets deposited on the surface of silica microspheres assembled in a close-packed fashion on a silicon substrate. Inset of (e) depicts a top-down view that the structures are thin and mostly transparent to the SEM. Scale bars are equal to 100 nm, 500 nm, 1 μm, 400 nm, and 1 μm for (b), (c), (d), (e), and the inset of (e), respectively.

FIG. 2 shows the SERS properties of the nanosheets. (a) SERS spectra of a sample of nanosheets functionalized with 1,4-benzenedithiol using both a confocal Raman microscope with a 100× objective (trace (i)) and a 20× objective (trace (ii)) and a portable Raman spectrometer (trace (iii)), illustrating the change in signal-to-noise as the measurement resolution is decreased from the single dimer (100×, i) regime to the many sheet regime (portable, iii). The presence of the peak from silicon is denoted by (*) in trace (i). (b) SERS spectra collected with a 20× objective on a confocal Raman microscope for nanosheets with varying dimer densities (˜40, 21, 12, and 5 dimers/μm² from the top traces to the bottom traces, respectively) that have been functionalized with 1,4-benzenedithiol, which illustrates a minimum standard deviation (σ) for an intermediate density (˜12 dimers/μm²). Spectra in both (a) and (b) are offset for clarity.

FIG. 3 shows detection of benzocaine on the surface of a dollar bill. (a) Raman spectra demonstrating the ability to detect trace amounts of benzocaine (top spectrum is of crystalline benzocaine) on a dollar with the nanosheets (second from top trace is with the sheets present). No appreciable signal is observed over background for control with only the dollar (bottom trace) or the dollar plus the benzocaine without the nanosheets deposited on top (second from bottom trace, see scheme on right). Spectra offset for clarity. (b, c) SEM images of the surface of the dollar after depositing the sheets on top. (b) The complex, fibrous topography of the surface of the dollar is shown. Scale bar is 100 μm. (c) A zoomed-in image showing 1-3 nanosheets that have attached and conformed to the side of one fiber on the bill, illustrating their unique ability to be dispensed predictably onto complex surfaces. Scale bar is 2 μm.

FIG. 4 shows anti-counterfeiting with nanosheet codes. (a) Photograph of the region where the nanosheets are deposited on each of the seventeen bills used in this double-blind example. (b) Photograph depicting use of the hand-held, portable Raman spectrometer during analysis of the bills. (c) Example spectra before (i) and after (ii) subtracting the background signal for the dollar with the serial number beginning with A1893. The solid lines correspond to the presence of peaks and constitute the barcode used for comparison to the standard codes. (d) Examples comparing the code generated in (c) to the two closest matches (3-chlorobenzenethiol on the left and 4-methylbenzenethiol on the right), where solid lines indicate a match between the two and dashed lines indicate a peak that is only present in one. The bill is positively matched to 3-chlorothiophenol in this case (˜84% match), demonstrating successful analysis of the code.

FIG. 5 shows a schematic for nanosheet synthesis. Scheme illustrating the synthesis of the nanosheets, beginning with the synthesis of Au—Ni striped nanowires and subsequent vacuum filtration onto polycarbonate membranes. A thin film of SiO₂ (usually 15 nm) is then deposited on top using electron beam evaporation, covering both the exposed sides of the nanowires and the porous PC surface. The templates are then placed into 10 mL of chloroform to dissolve the PC layer and recover the Au—Ni nanorod embedded silica sheets. After washing, the Ni segments are etched using phosphoric acid, and the sheets can then be dispensed on any surface and used.

FIG. 6 shows SEM images of the nanosheets deposited on a number of complex topographies. (a,b) Images of the wrapping around and adhering to a micron-sized silica sphere. (c) A group of nanosheets conforming to complex, random debris on a silicon wafer. (d) Nanosheets covering a group of Escherichia coli cells, where the boundary of covered and uncovered cells is visible.

FIG. 7 shows an example extinction spectra of nanosheets dispersed in water. The left trace corresponds to most of the structures studied in this work that are optimized at 785 nm. The right trace corresponds to the nanosheets used in the multimodal codes in FIG. 10.

FIG. 8 shows representative SEM images of the nanosheets used for the density study. (a-d) Images correspond to nanosheets with average densities of approximately 40, 21, 12, and 5 dimers (of nanowires)/μm², respectively. Scale bars are equal to 2 μm.

FIG. 9 shows spectra and corresponding barcodes for all seven of the codes used herein. From top to bottom, the molecules used are: 4-methoxythiophenol, 4-bromothiophenol, 3-chlorothiophenol, 4-methylthiophenol, 3-methoxythiophenol, 4-aminothiopenol (APT), and 1,4-benzenedithiol (1-4,BDT).

FIG. 10 shows three different ways to increase the sophistication of the codes by mixing. (a) One sample of nanosheets co-functionalized with two molecules (1,4-benzenedithiol and 4-aminothiophenol), where the relative peak heights (A and B, respectively) from each molecule are tailored by controlling their concentrations during functionalization (A:B in top right corner of each spectrum). Inset in each is an SEM image of the single sheet analyzed in each. (b) Two samples of sheets are functionalized separately (4-methylthiophenol and 3-methoxythiophenol in this case) and then mixed in solution and deposited on the surface-of-interest. (c) Two sets of nanosheets are synthesized with one resonant at 785 nm (i) and the other at 633 nm (ii). Each is functionalized with a dye that is resonant at the same wavelength (indocyanine green at 785 nm and methylene blue at 633 nm), and when the codes are mixed and dispensed on a surface, a multimodal code that reads a different spectrum at 785 nm (top) and 633 nm (bottom) results.

### DETAILED DESCRIPTION

Disclosed herein are SERS-active nanostructures immobilized relative to one another with a fixed, and tailorable, density when they are dispensed on surfaces to limit their ability to aggregate uncontrollably. The immobilized SERS-active nanostructures in nanosheets can then be used in a variety of SERS-detection methods, including as a way to detect counterfeit goods or currency.

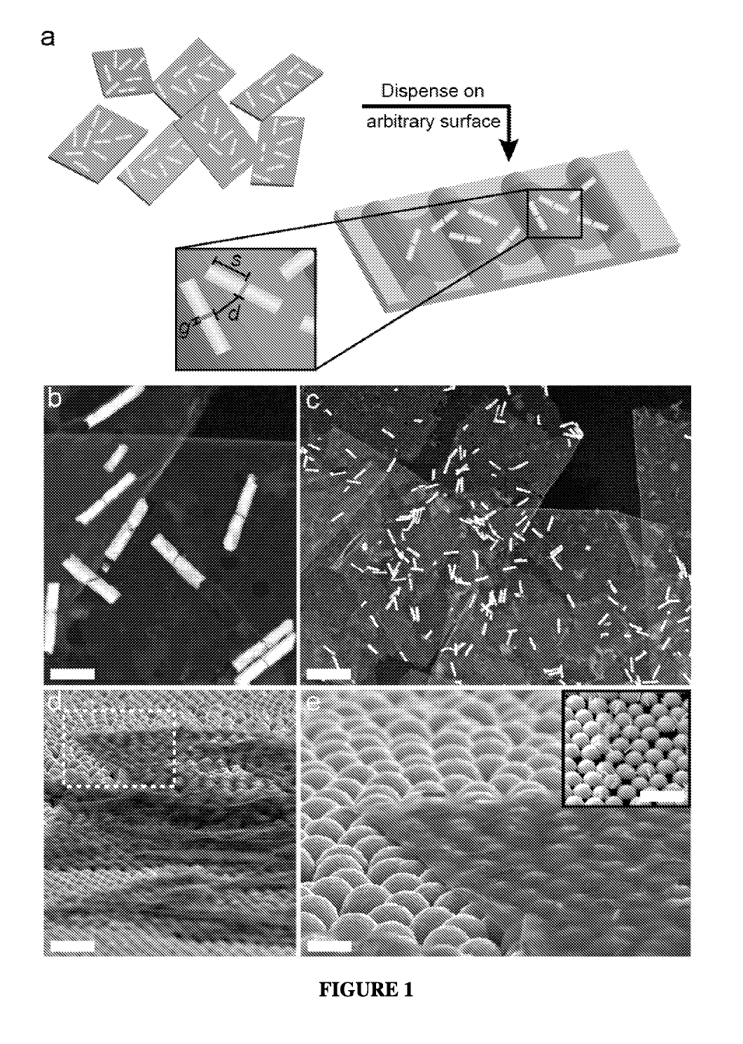

Thus, in some embodiments, nanosheets, micron-sized, ultra-thin and flexible sheets (e.g., silica sheets) with discrete, highly monodisperse metal nanowire dimers synthesized by on-wire lithography (OWL) (16-27) embedded uniformly throughout are provided, as one example of SERS-active nanostructures. The thickness of the nanosheets can be tuned from 5-20 nm, and the typical edge lengths are 1-4 microns (FIG. 1a). They are solution-dispersible and can be easily dispensed on an arbitrary support, conforming to its topography while maintaining the geometry of the SERS-active nanostructures that can generate an intense SERS signal. (23)

SERS-active nanostructures can have many different shapes, configurations, be made of many different materials, and be made by many different methods. The properties of SERS-active nanostructures can be tailored by controlling those properties in isolation or in combination. One way to make SERS-active nanostructures is with OWL. With OWL, all aspects of the optical properties of nanowire dimers embedded in the sheets can be controlled and is preserved during processing of the nanosheets. The average separation of the nanowire dimers with respect to one another (d), the length of the metal segments (s), and, importantly, the gap size between metal segments in the nanowires (g) are all easily tuned and are then conserved when deposited on surfaces. Thus, the composite nanosheets are not only a robust medium for the dispersion of nanowires from solution onto a variety of substrates, but they also impart controllable and reproducible SERS signal enhancements, making them ideal for many important applications involving macroscopic identification of chemicals present on uneven surfaces with SERS.

In the traditional OWL process, discrete, solution-dispersible arrays of nanostructures are synthesized using a thin sheath of SiO₂ that holds the particles together, leading to an ability to synthesize dispersible nanowires with tailorable dimensions and properties for SERS. (10, 16-18, 23) Provided herein is a way to prepare collections of these OWL nanowires that are held together by two-dimensional sheets of SiO₂. This process results in dispersible nanosheets where many nanowires (such as nanowire dimers, i.e., two nanowires) with well-defined nanogaps are embedded and held at fixed positions relative to one another, creating microscopic and macroscopic entities that avoid issues related to aggregation of the nanowires. The nanosheets can be less than 20 nm thick (which can be easily controlled during SiO₂ deposition) and can have 34.2±3.1 nm diameter metal segments in the nanowires, evenly distributed throughout (FIG. 1b, c). Importantly, the nanosheets are both flexible and robust, and can easily conform to the topography of a textured surface of a support without breaking apart (FIG. 1d, e). The sheets can also cover a number of other complex surfaces, including discrete cells deposited on a surface (e.g., cells, such as Escherichia coli), micron-sized spheres, and random surface topography (FIG. 6). In all cases, the nanosheets conformed to the morphology of the samples, effectively wrapping around them and positioning the nanowires in proximity to their highly convex surfaces.

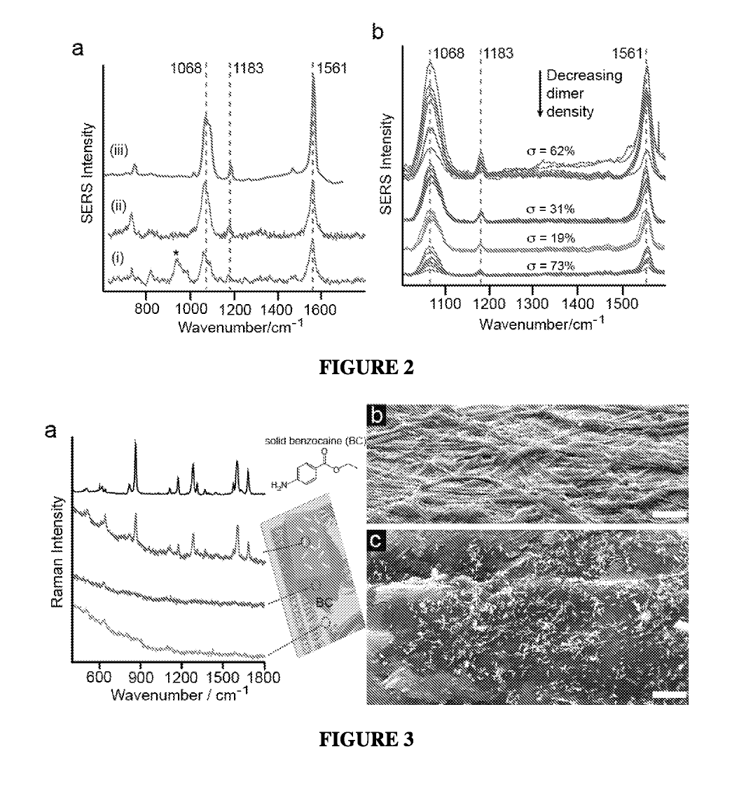

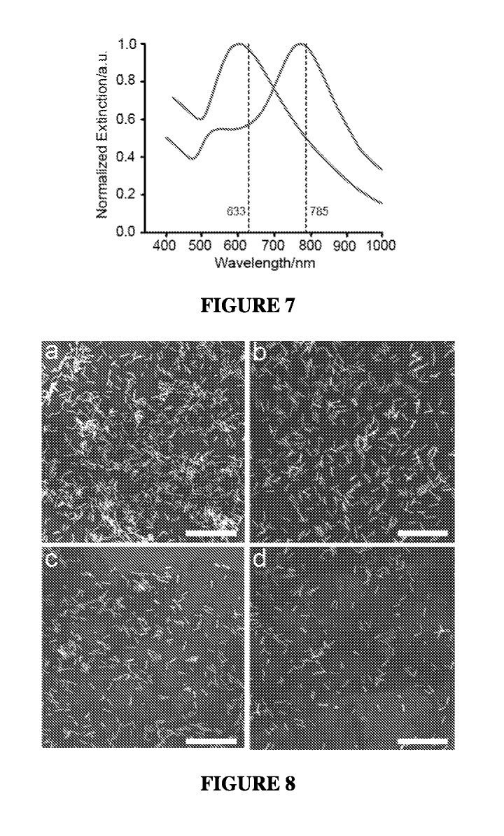

The nanosheets preserve the morphology of the nanowires after etching and dropcoating which maintains the SERS activity of the nanowires (FIG. 1b). (23, 28-30) The gaps between the metal segments can clearly be seen in the structures, and their sizes do not change after embedding the structures in the support (e.g., SiO₂), etching the sacrificial metal segments (e.g., Ni segments), or after further manipulation of the resulting nanosheets, such as dispersing the nanosheets in water. The nanowires are also distributed evenly across the nanosheets, and when dried on a substrate, this distribution is maintained (FIG. 1c). This result is nearly impossible to achieve with discrete particles, because they aggregate with one another or are drawn into cavities and other openings on a substrate, thereby limiting their effectiveness on corrugated surfaces. (31, 32) These aggregation issues are avoided with the disclosed nanosheets through the synthetic approach described herein. Instead of directly depositing these nanowires onto the nanosheets, the structures are first vacuum filtered onto porous polymeric membrane (e.g., polycarbonate membrane), which limits the capillary effects causing the particles to aggregate and results in a dispersed nanowire surface. A support is then deposited (e.g., a thin, e.g., 10-25 nm or 15 nm, film of SiO₂) onto this nanowire surface to create an intermediate that can then be released into solution via lift-off. In addition, by preventing the aggregation of the nanowires, their plasmonic properties, which were optimized for the individual nanowire dimers to have a plasmon resonance at a selected wavelength (in the example below at 785 nm), are not altered through proximity effects (i.e., plasmon coupling) (29) from neighboring nanowires or nanowire dimers (UV-vis spectrum of sheets dispersed in solution shown in FIG. 7). This results in a uniform and reproducible SERS signal from the nanosheets (FIG. 2) that would otherwise be difficult to realize with discrete particles and uneven surfaces alone.

Filtration is one example of how to overcome aggregation of the SERS-active nanostructures. Patterning methods can also be used alone or in combination to disperse the SERS-active nanostructures to form nanosheets where the SERS-active nanostructures are uniformly dispersed. For example, lithography (e.g. dip pen lithography, as described in U.S. Pat. No. 6,6353,11, or polymer pen lithography, as described in US 2011/0132220) or a transfer printing (Hatab, et al., ACS Nano, 2008, 2, 377) can be used to disperse the SERS-active nanostructures without the problem of aggregation.

The individual nanowires, incorporated into the nanosheets disclosed herein, are sensitive SERS substrates (enhancement factor of 10⁸-10⁹) that have been characterized by single-particle SERS measurements. (10) While high-resolution SERS on single nanostructures is useful for fundamental studies, (33) optimizing SERS structures for their use in meaningful applications requires the optimization of the signal strength and sensitivity. The nanosheet architecture accomplishes this by fixing the nanowires relative to one another in a controlled way so that many of the nanowire dimers can be simultaneously excited to produce large and reproducible SERS signals over large areas.

To understand how the SERS signal from the nanosheets would change as a function of the acquisition size (via measurement resolution), the nanosheets were functionalized with a 1,4-benzenedithiol (1,4-BDT) monolayer and dropcast on the surface of a silicon wafer. (34) Their SERS signal was then measured using both a confocal Raman microscope with 100× and 20× objectives and a portable Raman spectrometer with a laser spot size in the millimeter range (FIG. 2). In this case, the highest resolution measurement (100×) corresponds to measuring only a few dimers at a time (spot size ˜500 nm), whereas the lower resolution measurements (20× and portable) correspond to single-sheet and many-sheet regimes, respectively. Using the 100× objective (FIG. 2a, trace (i)), the Raman spectrum is comparable in signal to single dimer measurements on discrete OWL structures. (10) Increasing the acquisition area with the 20× objective (˜2 micron spot size, trace (ii)) and the portable Raman spectrometer (spot size in the millimeter range, trace (iii)) increases the signal-to-noise ratio in each case because of the increased sampling area where more nanowire dimers and more molecules are probed, highlighting another advantage of the macroscopic measurements on these nanosheets.

In addition to these improvements in signal intensity and ease of measurement, the ability to control and maintain the nanowire dimer density in the sheets has important implications for signal reproducibility. To study the effect of the dimer density on signal intensity and reproducibility, four unique sets of sheets with varying dimer densities (from ˜5-40 dimers/um²) were synthesized (FIG. 8). The nanosheets from each set were then functionalized with a SERS-active compound 1,4-BDT and dropcast onto silicon substrates, where spectra from ˜20 single sheets from each unique sample were acquired (FIG. 2b). As expected, the SERS signal intensity decreases as a function of decreasing dimer density in the nanosheets. Interestingly, the reproducibility in the signal from sheet to sheet also varies with the density of dimers present. In fact, as the density is decreased, a minimum standard deviation (σ) is reached at an intermediate dimer density (˜12 dimers/μm², second from bottom trace, σ=19%), indicating that a trade-off exists between large signal intensity and irreproducibility from aggregation when the structures are too dense. Conversely, the least dense sheets (˜5 dimers/μm², bottom traces, σ=73%) had the highest standard deviation due to incomplete coverage with regions without any dimers present. This result is critical, because it demonstrates how important control over and preservation of the density of these dimer hot spots is for signal reproducibility. With the disclosed method, one can easily tailor the density across a large range, while maintaining it when the sheets are dried on a variety of surfaces due to the presence of the SiO₂ support film holding the particles together.

Of the many powerful SERS properties of these nanosheets, the ability to dispense them on topographically complex surfaces in a controlled way can be useful. To this end, one particularly intriguing everyday substrate is currency notes (e.g., U.S. bills), where SERS hot spots can be envisioned for use in both trace detection of illicit drugs and authentication. Considering their surface (FIG. 3b), dollar bills are ideal for this first example for two important reasons: 1) it is difficult to deposit nanostructures onto the fibrous surface in a predictable and reproducible fashion, and 2) the cotton-based material and fluorescent anti-counterfeiting dyes can cause large backgrounds in the signal, especially at higher energy excitations. (35) The nanosheets evenly coat the fibrous surface due to their highly flexible nature (FIG. 3c), while background fluorescence is minimized by using dimers that are optimized for excitation at 785 nm.

First, as a demonstration of how one could simply deposit the nanosheets onto a U.S. bill to enhance the Raman signal from chemicals on the bill's surface, proof-of-concept experiments designed to illustrate the detection of illicit drugs on the front side of a dollar bill were performed (FIG. 3a). Benzocaine was chosen as a model in this case, because it is readily available and is commonly used as a marker for drugs due to its physical and chemical similarities to cocaine. (36, 37) Compared to the bulk Raman spectrum for solid benzocaine (top trace), the small quantities on the surface of the dollar can only be detected after the sheets have been deposited on the surface (second from top trace). Spectra taken of the dollar alone (bottom trace) and the dollar plus the benzocaine (without the nanosheets, second from bottom trace) do not have any of the characteristic peaks of benzocaine, indicating that its presence in the blue trace is due to the strong enhancement from the dimers embedded in the nanosheets. Importantly, this demonstrates an extremely easy and straightforward way of getting important chemical information from very complex, everyday surfaces in a non-destructive manner, which has a number of critical implications for detection applications.

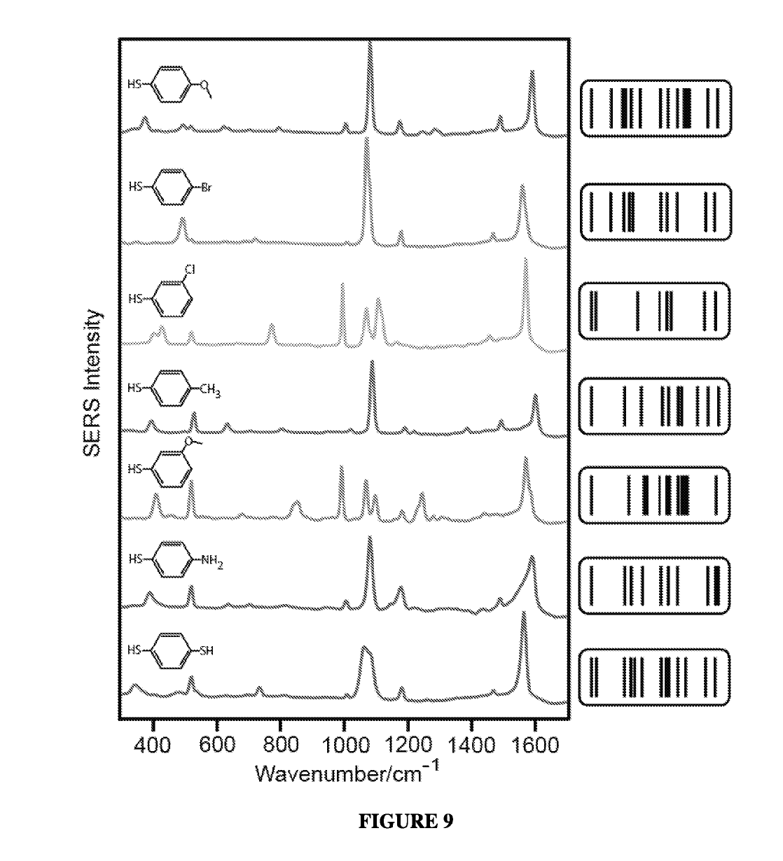

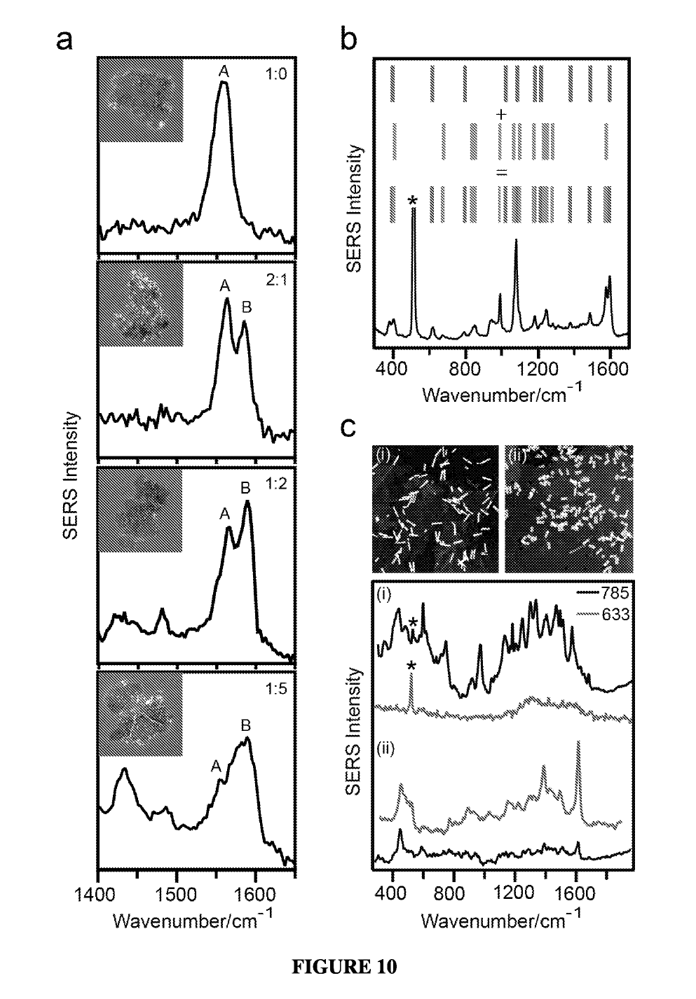

Another common research area related to currency notes focuses on the development of robust, covert, and easily readable authentication methods for anti-counterfeiting purposes. (38-41) The nanosheets, like many SERS platforms, are well suited for encoding schemes based on the SERS signal from a variety of SERS-active compounds, such as thiolated small molecules, that can serve as specific codes. By converting the SERS spectrum from a nanosheet into a one-dimensional barcode where the lines correspond to the presence and relative width of the peaks in the spectrum, one can envision an enormous library of potential codes that can be differentiated from one another with a portable Raman spectrometer (the seven unique codes used in this work shown in FIG. 9). In addition, the nanosheets are robust and maintain their conformation, while also providing stable signals over long periods of time (months) that can be easily processed into a barcode and analyzed.

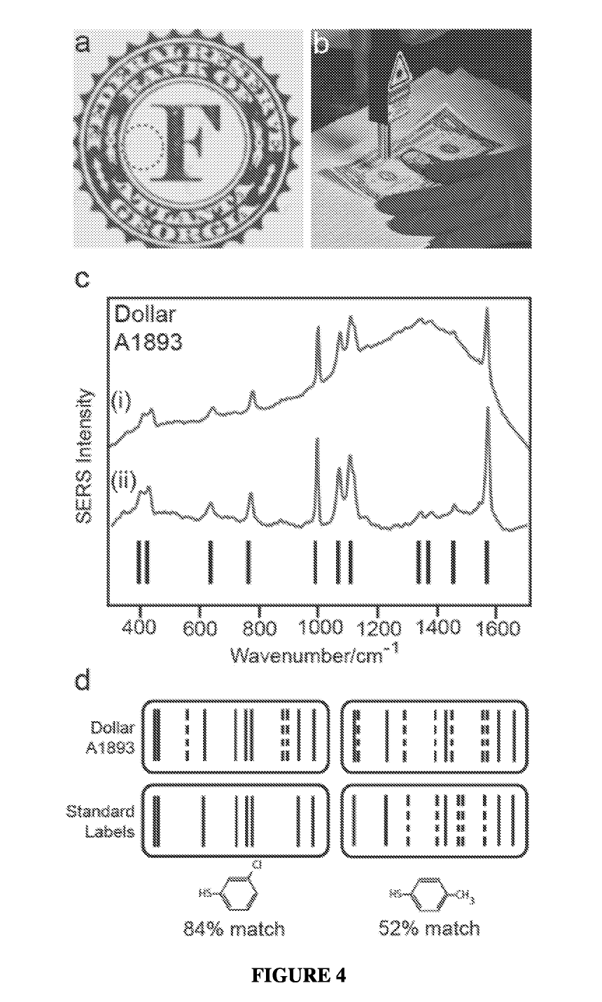

Having introduced the concept behind the encoding and readout schemes, the nanosheet codes were deposited on currency notes to test their performance as authentication labels. To do this, a double-blind study was designed where each U.S. bill (out of seventeen total bills) was tagged with a unique label (FIG. 9) by dispensing a very small volume (<1 μL) of a particular code over a millimeter-sized area in the same location on each dollar bill (FIG. 4a). A portable Raman spectrometer was then used to analyze each dollar bill at this location to test whether it could be correctly matched with the label used for tagging it (FIG. 4b). Measured directly from the dollar bill in the portable Raman spectrometer, a background is observed from the dollar, but the Raman peaks from the labels are clearly observed over this background (FIG. 4c, i). After subtracting the background (FIG. 4c, ii), the spectrum from each dollar can be converted into a barcode (black lines under the spectra) and can be compared to the library of standard labels for the codes used in this study (FIG. 9). In this case, the two standards that matched this particular dollar (serial number beginning with A1893) the closest are compared with the barcode generated from the SERS spectrum, where black lines indicate peaks that are a match between the two and dashed lines indicate those that are not (FIG. 4d). The barcode can easily be identified as 3-cholorothiophenol (left, ˜84% match compared to ˜52% for 4-methylthiophenol on the right, which was the second closest match). In this same way, each of the other sixteen dollars was also correctly identified with >75% match in every case, demonstrating a new encoding material that can be used easily and reproducibly while being invisible to the naked eye and very difficult to counterfeit.

The synthesis, characterization, and application of a new silica-based nanosheet material for the delivery of metal nanostructures to complex environments is provided herein. These nanosheets effectively harness the SERS from individual nanowire dimers and create a collective SERS signal that is macroscopically addressable, reproducible, and strong. Coupled with the ability to tailor the optical properties of each dimer, the unique ability of the nanosheets to conform to complex materials while maintaining the geometry and integrity of the dimers makes this a new platform for SERS. Furthermore, this new platform is implemented for use on a complex everyday object, a dollar bill, and demonstrate the detection of a known marker for illicit drugs, as well as their use as nanoscale barcodes that are easily scanned and cannot be observed by the naked eye.

### SERS-Active Nanostructures

SERS-active nanostructures can be any structure that enhances Raman scattering. SERS-active nanostructures can have many different shapes, configurations, be made of many different materials, and be made by many different methods. The properties of SERS-active nanostructures can be tailored by controlling those properties in isolation or in combination. The specific examples of SERS-active nanostructures provided herein are nonlimiting.

SERS-active nanostructures can have many different shapes, including spherical, cylindrical, ribbon-like, prismatic, cubic, pyramidal, octahedral, octapod-shaped, and other structures are possible. Examples include nanospheres, nanoprisms, bipyramids, nanowires (which include nanodisks), nanocubes, nanoribbons, nanooctahedra, and nanooctapods. In some cases, the SERS-active nanostructures have sharp edges or tips, as sharp edges or tips can increase SERS activity. When SERS-active nanostructures are configured in proximity to each other, the SERS affect can be increased. For example dimer or trimer SERS-active nanostructures exhibit enhanced activity compared to isolated SERS-active nanostructures. SERS activity can be enhanced by adjusting the distance between the SERS-active nanostructures embedded in the disclosed nanosheets. The orientation of anisotropic SERS-active nanostructures can also enhance SERS activity. For example, tip-to-tip configured nanoprisms have enhanced SERS activity relative to tip-to-face configured nanoprisms. See, e.g., Wustholz, et al., J. Am. Chem. Soc., 2010, 132, 10903; Chen, et al., J. Am. Chem. Soc., 2010, 132, 3644; Mulvihill, et al., J. Am. Chem. Soc., 2010, 132, 268; Rycenga, et al., Angew. Chem., Int. Ed., 2011, 50, 5473; Hatab, et al., Nano Lett., 2010, 10, 4952; Caldwell, et al., ACS Nano, 2011, 5, 4046; Chen, et al., J. Mater. Chem, 2012, 22, 6251.

SERS-active nanostructures can comprise one or more SERS-active materials. For example, metals, metal alloys, metal oxides, and semiconductors can have SERS-activity. Several examples of plasmonic substrates for SERS include Au, Ag, Cu, Li, Na, K, Rb, Cs, Al, Ga, In, Pt, Rh, graphene, NiO, and TiO₂. See, e.g., Sharma, et al., Materials Today, 2012, 15, 16; Yamada, et al., Surface Sci., 1983, 134, 71. In some cases, the SERS-active nanostructures comprise one or more of gold, silver, and copper.

Further, the SERS-active nanostructures can be a metal in combination with a reporter or Raman-active molecule. For example, Nanoplex biotags (Oxonica Inc.) comprise one or more SERS-active metals and a sub-monolayer of reporter molecules absorbed to the metal surface. Further still, SERS-active nanostructures can be coated, for example, with silica. For example, glass-coated, analyte-tagged nanoparticles are core-shell particles where a nanometer-scale Au or Ag core is functionalized with Raman-active molecules and encapsulated in a glass shell. (Mulvaney, et al., Langmuir, 2003, 19, 4784; Sha, et al., J. Am. Chem. Soc., 2008, 130, 17214)

SERS-active nanostructures can be also be made through a number of techniques, including chemical and photochemical synthesis, electron beam lithography, on-wire lithography (OWL), or any other suitable method. (U.S. Pat. Nos. 7,588,624; and 7,776,130; Personick et al., Nano Letters, 11:3394 (2011); Hatab, et al., ACS Nano, 2008, 2, 377; Hatab, et al., Nano Lett., 2010, 10, 4952; Caldwell, et al., ACS Nano, 2011, 5, 4046; Wells, et al., Chem. Comm., 2011, 47, 3814)

### On-Wire Lithography and Preparation of Nanowires

One can systematically synthesize nanorods that contain metals of different properties via template-assisted in-situ electrochemical depositions, and that such rod-structures can be tailored through choice of segment composition. The approach can be contrasted with the alternative layer-by-layer approach for synthesizing rod structures in two ways. First, the electrochemical approach offers greater control over the architectural parameters of the resulting structures (in particular segment length). Second, the properties (e.g., turn on voltages) of the resulting structures substantially differ, even when comparable materials are used. It is theorized that this difference is attributed to junctions formed in the layer-by-layer approach being less well defined because the active materials are introduced as a polymer particle dispersion with little control over where the active interface is formed. In the electrochemical approach, only conducting materials can be deposited within the pores. This is an adaptable method for producing nanostructures having predetermined desirable electrical properties by a straightforward synthetic procedure that offers a high degree of reproducibility.

The process of segment-by-segment formation of nanorods can then be used in the formation of nanowires. These nanowires have electronic properties that can be tailored from their compositional components (i.e., the identities of the metals forming the nanorods). The use of metals having different chemical and electrical properties allows the creation of gaps in these nanowires where the nanowire is treated with a solution that dissolves a certain metal but not the other metal. These gaps allow the formation of facing electrodes with controlled gaps, which is an important goal of nanoelectronics. This technique of selectively stripping out, or etching, one metal segment type (i.e., the sacrificial metal segment) in the presence of different metal segment types to form gaps has been named on-wire lithography (OWL). OWL is described in detail, e.g., in U.S. Pat. No. 7,422,969, the disclosure of which is incorporated by reference in its entirety.

As used herein, the term “nanowire” refers to the product of on-wire lithography, comprising coated nanorods that have been subjected to etching to dissolve a sacrificial metal, leaving gaps where the sacrificial metal segments were positioned prior to etching. In some cases, the gap is between about 2 nm and about 500 nm. Other gap ranges contemplated include in the range of about 5 and about 160 nm. Specific examples of gap sizes include 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, and 500 nm. In other cases, the gap is greater than 500 nm. Gaps up to and including 2 μm may also be incorporated into a nanowire. In some cases, a gap of the nanowire can be at least 500 nm and can be up to 2 μm. The metal segments remaining in the nanowire can be of a thickness of about 20 nm to about 500 nm, about 40 nm to about 250 nm, and about 50 nm to about 120 nm. Specific thickness contemplated for use in the present invention include less than 35, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 310, 320, 330, 340, 350, 360, 370, 380, 390, 400, 410, 420, 430, 440, 450, 460, 470, 480, 490, and 500 nm. In some cases, the thickness of the metal segments remaining in the nanowire is at least 500 nm and can be up to 2 μm.

As used herein, the term “sacrificial metal” refers to a metal that can be dissolved under the proper chemical conditions. Examples of sacrificial metals include, but are not limited to, nickel which is dissolved by nitric acid, and silver which is dissolved by a methanol/ammonia/hydrogen peroxide mixture.

As used herein, the term “etching” refers to a process of dissolving a sacrificial metal segment using conditions suitable for dissolving or removing the metal comprising the sacrificial segment. As mentioned above, such etching solutions include, but are not limited to, nitric acid and a methanol/ammonia/hydrogen peroxide mixture.

As used herein, “coating” refers to a material that is positioned to contact one side of a nanowire. The purpose of the coating is to provide a bridging substrate to hold segments of the etched nanowires together after removal of the intervening sacrificial metal segments in the etching process. Nonlimiting examples of coatings used in this invention include a gold/titanium alloy and silica. This coating is optional in the case for nanosheets, as the support of the nanosheet can itself operate to hold the metal segments together and nanowires at constant distances from each other.

OWL is based upon manufacturing segmented nanowires comprising at least two materials, one that is susceptible to, and one that is resistant to, wet chemical etching. There are a variety of material pairs that can be used. Au—Ag and Au—Ni are two such examples of metal pairs of differing chemical properties. The sacrificial metal in these pairs are Ag and Ni, respectively. However, any combination of metals having contrasting susceptibility to chemical etching conditions can be used.

The etching of the sacrificial metal segments can occur before or after the nanowires are deposited on a support to form a nanosheet. In cases where the etching occurs before, a coating is employed to maintain the metal segments and gap integrity.

### Assemblies of SERS-Active Substrates on a Support to Form the Nanosheet

SERS-active substrates, such as nanowires, can be embedded onto a support, e.g., a silica nanosheet. The embedding of the SERS-active substrates can be by dispersing the SERS-active substrates into a compatible solution (e.g., water, ethanol, mixtures thereof) and filtering the dispersed solution onto either an arbitrary support or the support that remains in the nanosheet. The filtering can be by, e.g., vacuum filtration. The arbitrary support comprises a material that can be removed without substantial impact on the nanosheet. For example, SERS-active substrates can be dispersed onto a polycarbonate membrane (the arbitrary support), then a silica layer can be deposited on top of the dispersed SERS-active substrates to form a silica support. Lastly, the arbitrary support (here polycarbonate) can be removed, leaving the SERS-active substrates dispersed on the silica support, providing the nanosheet. It will be appreciated that the arbitrary support can be of any material that can be removed in the presence of the support. Polycarbonate is simply one such example.

Other means of depositing the SERS-active substrates onto the support are contemplated, including by lithography of the support (e.g., pattering a portion of the support with an affinity material to bind the SERS-active substrates to the support), or by self assembly of a monolayer of SERS-active substrates onto an arbitrary support then deposition of the support material on top of the monolayer and removal of the arbitrary layer.

### Detection of Analytes Using Nanosheets and SERS

When certain molecules are illuminated (e.g., SERS-active compounds), a small percentage of the molecules which have retained a photon do not return to their original vibrational level after remitting the retained photon, but drop to a different vibrational level of the ground electronic state. The radiation emitted from these molecules is at a different energy and hence a different wavelength. This is referred to as Raman scattering.

If the molecule drops to a higher vibrational level of the ground electronic state, the photon emitted is at a lower energy or longer wavelength than that retained. This is referred to as Stokes-shifted Raman scattering. If a molecule is already at a higher vibrational state before it retains a photon, it can impart this extra energy to the remitted photon thereby returning to the ground state. In this case, the radiation emitted is of higher energy (and shorter wavelength) and is called anti-Stokes-shifted Raman scattering. In any set of molecules under normal conditions, the number of molecules at ground state is always much greater than those at an excited state, so the odds of an incident photon hitting an excited molecule and being scattered with more energy than it carried upon collision is very small. Therefore, photon scattering at frequencies higher than that of the incident photons (anti-Stokes frequencies) is minor relative to that at frequencies lower than that of the incident photons (Stokes frequencies). Consequently, it is the Stokes frequencies that are usually analyzed.

The amount of energy lost to or gained from a molecule in this way is quantized, resulting in scattered photons having discrete wavelength shifts. These wavelength shifts can be measured by a spectrometer. Raman spectroscopy is one useful analytical tool to identify certain molecules, and as a means of studying molecular structure. Other useful spectroscopic methods include fluorescence, infrared, nuclear magnetic resonance, and the like.

A significant increase in the intensity of Raman light scattering can be observed when molecules are brought into close proximity to (but not necessarily in contact with) certain metal surfaces. The increase in intensity can be on the order of several million-fold or more, and has been coined “surface-enhanced Raman scattering” (SERS).

The cause of the SERS effect is not completely understood. However, at least two separate factors have been identified as contributing to SERS. First, metal surfaces often contain minute irregularities, which can be thought of as spheres. Those irregularities having diameters of approximately 1/10th the wavelength of the incident light are considered to contribute most to the effect. The incident photons induce a field across the particles which have very mobile electrons (due to the nature of metals).

In certain configurations of metal surfaces or particles, groups of surface electrons can be made to oscillate in a collective fashion in response to an applied oscillating electromagnetic field. Such a group of collectively oscillating electrons is called a “plasmon.” The incident photons supply this oscillating electromagnetic field. The induction of an oscillating dipole moment in a molecule by incident light is the source of the Raman scattering. The effect of the resonant oscillation of the surface plasmons is to cause a large increase in the electromagnetic field strength in the vicinity of the metal surface. This results in an enhancement of the oscillating dipole induced in the scattering molecule and hence increases the intensity of the Raman scattered light. The effect is to increase the apparent intensity of the incident light in the vicinity of the particles.

A second factor contributing to the SERS effect is molecular imaging. A molecule having a dipole moment and in close proximity to a metallic surface will induce an image of itself on that surface of opposite polarity (i.e., a “shadow” dipole on the plasmon). The proximity of that image is thought to enhance the ability of the molecules to scatter light. The coupling of a molecule having an induced or distorted dipole moment due to the surface plasmons greatly enhances the excitation probability and results in an increase in the efficiency of Raman light scattered by the surface-absorbed molecules.

The SERS effect can be enhanced through combination with the resonance Raman effect. The surface-enhanced Raman scattering effect is even more intense if the frequency of the excitation light is in resonance with a major absorption band of the molecule being illuminated. The resultant Surface Enhanced Resonance Raman Scattering (SERRS) effect can result in an enhancement in the intensity of the Raman scattering signal of seven orders of magnitude or more.

Nanosheets as described above can act to detect small concentrations of SERS-active compounds, and their detection abilities are tailorable by choice of the gap between metal segments in the wire and the density of the nanowire dimers in the nanosheets. The number of gaps in a nanowire can vary. At least one gap must be present. Gaps numbering from 1, 2, 3, 4, 5, 6, 7, 8, 9, and 10 can all be incorporated into a nanowire. The number of gaps in a nanowire determines the number of metal segments (alternatively referred to throughout as “nanodisk”) in the array. For example, one gap correlates to two nanodisks; two gaps correlate to three nanodisk; and three gaps to four nanodisks.

The surfaces of nanodisks are clean, i.e., free from contamination of stabilizing surfactants or other organic chemicals, because the OWL synthetic process uses nitric acid which removes essentially all organic compounds from the surface of the nanodisks. This clean surface allows for better functionalization and also decreases Raman scattering noise attributed to surface contaminants. Detection of small analyte concentrations or probe molecules therefore is enhanced due to the decreased scattering noise and tailorable functionalization of the nanodisks.

Different metals can be incorporated into the nanowires by simple modifications to the synthesis. Nonlimiting examples of metals that can be incorporated include silver (Ag), gold (Au), and copper (Cu).

In an analysis of a sample containing or suspected of containing an analyte of interest, a nanosheet as disclosed herein is contacted with the sample. A radiation source is selected to generate radiation having a wavelength that causes appreciable Raman scattering in the presence of the analyte being measured. Although it is known that Raman scattering occurs at all wavelengths, the radiation typically employed will be near infrared radiation because ultraviolet radiation often causes fluorescence.

In some cases, the analyte is one or more of 4-methoxythiophenol, 4-bromothiophenol, 3-chlorothiophenol, 4-methylthiophenol, 3-methoxythiophenol, 4-aminothiophenol, and 1,4-benzenedithiol. These analytes are of interest because the SERS spectra are distinguishable between them and make them useful as codes for, e.g., labeling of goods and detection of counterfeit goods.

The radiation source can be any source that provides the necessary wavelength to excite the analyte for detection using Raman spectroscopy. Typically, a laser serves as the excitation source. The laser may be of an inexpensive type, such as a helium-neon or diode laser. In some embodiments, a narrow bandwidth, high frequency, amplitude and modal stability, and no sidebands or harmonics are important characteristics of the laser. Lamps also can be used. The radiation sources used can be monochromatic or polychromatic, and also can be of high intensity. In one embodiment, the radiation source provides a high enough photon flux that the Raman transitions of the analyte are saturated, in order to maximize the SERS signal.

Several methods are available for detecting Raman scattering. These methods generally can be used with different types of spectrometers. In SERS, the primary measurement is one of light scattering intensity at particular wavelengths. SERS requires measuring wavelength-shifted scattering intensity in the presence of an intense background from the excitation beam. The use of a Raman-active substance having a large Stokes shift simplifies this measurement. Methods for further simplifying the readout instrument are contemplated, such as the use of wavelength selective mirrors or holographic optical elements for scattered light collection.

Neither the angle of the incident light beam to the surface nor the position of the detector is critical for SERS analysis. With flat surfaces, positioning the surface of the excitation source at 60 degrees to the normal is typical, and detection at either 90 degrees or 180 degrees to the source is standard. SERS excitation can be performed in the near infrared range, which minimizes excitation of intrinsic sample fluorescence. SERS-based ligand binding assays using evanescent waves propagated by optical waveguides can also be performed. For non-flat surfaces, the wavelength and angle are important and give rise to scattering.

No signal development time is required as readout begins immediately upon illumination and data can be collected for as long as desired without decay of signal unless the excitation light is extremely intense and chemical changes occur. Unlike fluorescent readout systems, SERS reporter groups will not self-quench so the signal can be enhanced by increasing the number of Raman active reagent molecules. Fluorescent molecules near the SERS-active surface will actually be surface-quenched. The SERS effect can be excited by direct illumination of the surface or by evanescent waves from a waveguide beneath the plasmon-active surface.

The nanosheet characteristics also can be tuned to provide means for detecting analytes using other spectroscopic means. Smaller disk thicknesses (e.g., less than 400 nm) and gaps (e.g., less than 100 nm) are more suitable for optics detection (Raman spectroscopy, fluorescence, and the like), while larger disk thicknesses (e.g., between about 500 nm and about 2 μm) and gaps (e.g., between about 100 nm and about 1 μm) are more suitable for microwave applications. Depending upon the excitation and detection method, the nanowire can be tailored to provide optimum characteristics. In some embodiments, the spacing of the nanodisks are set at odd multiples of one-fourth the wavelength in order to produce a resonant cavity that enhances the field strength; even multiples do not enhance, but rather, suppress emissions.

Thus, as disclosed herein, the nanosheets embedded with known analytes (such as the “code” analytes noted above) that are affixed to a good (e.g., currency notes) and detection of which can serve to assess whether that good is counterfeit. In some cases, the nanosheets are used to detect the presence of illicit drugs, such as cocaine, which is a SERS-active compound.

Additional aspects and details of the invention will be apparent from the following examples, which are intended to be illustrative rather than limiting.

### EXAMPLES

Nanowire synthesis: The method for producing all the nanowires has been described in detail in previous publications (15-16). Briefly, Au—Ni nanowires were synthesized electrochemically in anodized aluminum oxide (AAO) membranes purchased from Synkera Technologies, Inc. with nominal pore diameters of 35 nm. Au was deposited at −1100 mV (vs. Ag/AgCl reference) using concentrated Orotemp 24 Rack plating solution (Technic, Inc.), and Ni was deposited at −1100 mV using Nickel Sulfamate plating solution (Technic, Inc.) diluted 100 times. After releasing the nanowires from the AAO templates by dissolving the AAO in 0.5 M NaOH, the wires were rinsed by spinning them down using a benchtop centrifuge at 5000 rpm and subsequently resuspending them in H₂O (with 0.1% sodium citrate) four times.

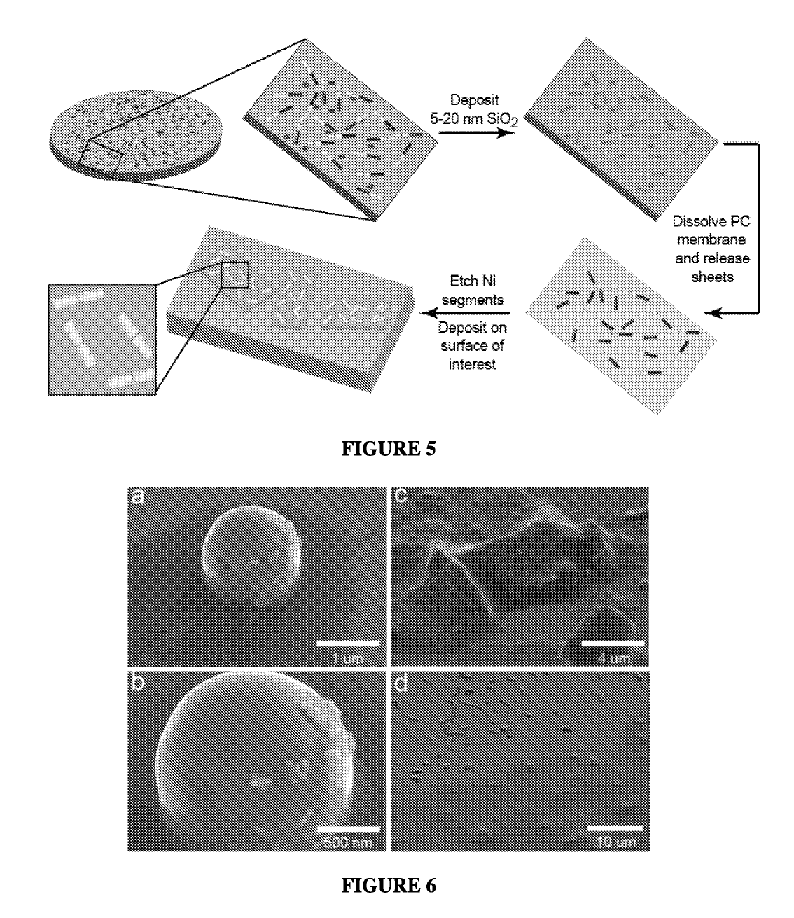

Nanosheet synthesis: The synthetic procedure is depicted schematically in FIG. 5. After synthesizing the wires and washing them several times in water, the striped Au—Ni nanowires were diluted into 6 mL of H₂O and then sonicated and vacuum filtered onto polycarbonate membranes (50 nm pore, 47 mm membranes from Sterlitech Corp.). In order to do this, the polycarbonate membranes (PC) were first attached to aluminum oxide membranes (Whatman Anodisc 100 nm pores, 47 mm membranes, GE Healthcare) to serve as a support for the more flexible PC membranes by using small amounts (˜10 μL) of chloroform to adhere the membranes together on their outer regions. For the filtration process, 3 PC membranes were used per nanowire synthesis and 2 mL was dispensed and vacuum filtered through each one to disperse the wires. In order to vary the density of the nanowires, the concentration of the nanowires and the number of templates used was varied (between 1 and 6 membranes per nanowire synthesis). 15 nm of SiO₂ (as measured by the built-in quartz crystal microbalance) was then deposited on the surface of the nanowires/PC membranes at a deposition rate of 0.02 nm/s (Kurt J. Lesker PVD 75 e-beam evaporator). After SiO₂ deposition, the PC membranes were placed into 10 mL of chloroform to dissolve the underlying polymer and recover the SiO₂ nanosheets containing the Au—Ni nanowires into solution. The nanostructures were then washed two times in chloroform, followed by two times in acetone and two times in water. Finally, the sheets were suspended in a 25% H₃PO₄ solution in water for 2 hours to etch away the Ni segments, leaving well-formed Au nanorod dimers embedded in the silica sheets. With a final rinsing step, the dimers are now ready for further functionalization and Raman characterization. UV-vis spectra were collected on a Cary 5000 UV-vis-NIR spectrometer (Varian). TEM/STEM images were collected on a Hitachi HD-2300A Scanning Transmission Electron Microscope, and SEM images were collected on a Hitachi S-4800 SEM.

Nanosheet Functionalization and SERS Measurements: For the Raman characterization and encoding studies, the nanosheets were functionalized with a 1 mM ethanolic solution of the thiolated molecule (1,4-benzenedithiol for characterization studies and a number of similar molecules for the encoding, FIG. 9) over a period of 2 h. Ethanol was used to wash the samples several times before resuspension in water to be dispensed and analyzed. For the benzocaine detection experiments, trace amounts of benzocaine were added to the dollar bill by crushing small crystals of solid benzocaine against the surface of the bill. A nitrogen gun and a laboratory wipe were then used to remove as much of the benzocaine as possible, leaving trace amounts that could only be detected with the enhancing nanosheets.

Confocal SERS Measurements: All confocal Raman data was collected on a Witec Instruments Corp. Alpha300 outfitted with 20× and 100× Nikon objectives. The 785 and 633 nm excitation sources were semiconductor continuous wave diode lasers and were used with a holographic notch filter with a grating of 600 lines per millimeter. The backscattered Raman signals were collected on a thermoelectrically cooled (−60° C.) CCD detector. For the 785 nm excitation, confocal SERS data was collected with Plaser=3.1 mW and t=20 s, whereas at 633 nm, it was collected with Plaser=5.3 mW and t=20 s.

Portable Raman SERS Measurements: All portable Raman data was collected on an Enwave Optronics, Inc. EZ-Raman-I-785 portable Raman spectrometer outfitted with a 785 nm laser and used at a 7 mm working distance. The backscattered Raman signals were collected on a thermoelectrically cooled (−50° C.) CCD detector. Portable SERS data was collected with λₑₓ=785 nm, Plaser=3.1 mW, and t=5 s. Processing of all the Raman spectra and all data analysis was done with IGOR Pro software (Portland, Oreg.). All data was baseline corrected before normalization. For the baseline correction, a fourth order polynomial was fitted to the raw Raman spectrum and subtracted.

### REFERENCES

[1] Kneipp, et al., Phys. Rev. Lett. 1997, 78, 1667.
[2] Nie, et al., Science 1997, 275, 1102.
[3] Dieringer, et al., J. Am. Chem. Soc. 2008, 131, 849.
[4] Dieringer, et al., J. Am. Chem. Soc. 2007, 129, 16249.
[5] Wustholz, et al., J. Am. Chem. Soc. 2010, 132, 10903.
[6] Camden, et al., J. Am. Chem. Soc. 2008, 130, 12616.
[7] Cao, et al., Science 2002, 297, 1536.
[8] Li, et al., Angew. Chem., Int. Ed. 2010, 49, 164.
[9] Camargo, et al., Angew. Chem., Int. Ed. 2009, 48, 2180.
[10] Osberg, et al., Nano Lett. 2012.
[11] Chen, et al., J. Am. Chem. Soc. 2010, 132, 3644.
[12] Chen, et al., J. Am. Chem. Soc. 2009, 131, 4218.
[13] Li, et al., Nature 2010, 464, 392.
[14] Li, et al., J. Am. Chem. Soc. 2011, 133, 15922.
[15] Xue, et al., Small 2005, 1, 513.
[16] Qin, et al., Science 2005, 309, 113.
[17] Banholzer, et al., Nat. Protoc. 2009, 4, 838.
[18] Osberg, et al., Nano Lett. 2011, 11, 820.
[19] Zheng, et al., Angew. Chem., Int. Ed. 2008, 47, 1938.
[20] Zheng, et al., Small 2009, 5, 2537.
[21] Wei, et al., Nano Lett. 2008, 8, 3446.
[22] Wei, et al., Angew. Chem., Int. Ed. 2009, 48, 4210.
[23] Qin, et al., Proc. Natl. Acad. Sci. U.S.A. 2006, 103, 13300.
[24] Qin, et al., Small 2007, 3, 86.
[25] Qin, et al., Nano Lett. 2007, 7, 3849.
[26] Chen, et al., Nano Lett. 2009, 9, 3974.
[27] Chen, et al., J. Am. Chem. Soc. 2008, 130, 8166.
[28] Li, et al., Nano Lett. 2010, 10, 1722.
[29] Kelly, et al., J. Phys. Chem. B 2003, 107, 668.
[30] McMahon, et al., J. Phys. Chem. C 2011, 116, 1627.
[31] Rabani, et al., Nature 2003, 426, 271.
[32] Pakowski, Transport Porous Media 2007, 66, 19.
[33] Rycenga, et al., J. Phys. Chem. Lett. 2010, 1, 696.
[34] Joo, et al., J. Colloid Interface Sci. 2001, 240, 391.
[35] Noonan, et al., Appl. Spectrosc. 2005, 59, 1493.
[36] Sabino, et al., Am. J. Anal. Chem. 2011, 2, 658.
[37] Arufe-Martinez, et al., J. Anal. Toxicol. 1988, 12, 192.
[38] Liu, et al., Nanoscale 2011, 3, 4804.
[39] Johansen, et al., Nanoscale Res. Lett. 2012, 7, 262.
[40] Hu, et al., J. Mater. Chem. 2012, 22, 11048.
[41] Eberlin, et al., Analyst 2010, 135, 2533.

What is claimed:

1. A nanosheet comprising (a) at least two SERS-active nanostructures and (b) a support;
wherein
the support holds the at least two SERS-active nanostructures at a distance relative to each other.

2. The nanosheet of claim 1, wherein one of the at least two SERS-active nanostructures is at least partially embedded in the support.

3. The nanosheet of claim 1 or 2, wherein one of the at least two SERS-active nanostructures is a nanosphere, nanoprism, bipyramid, nanowire, nanocube, nanoribbon, nanooctahedron, and nanooctapod.

4. The nanosheet of any one of claims 1 to 3, wherein one of the at least two SERS-active nanostructures has an edge or tip.

5. The nanosheet of any one of claims 1 to 4, wherein one of the least two SERS-active nanostructures is a dimeric or trimeric structure.

6. The nanosheet of any one of claims 1 to 5, wherein one of the at least two SERS-active nanostructures is a nanorod comprising a metal segment having a thickness of about 35 nm to about 1 μgm.

7. The nanosheet of claim 1, wherein at least one of the at least two SERS-active nanostructures are a dimer comprising nanowires
wherein
each of the at least two nanowires comprises at least two metal segments and a gap separating the metal segments, the metal segments having a thickness of about 35 nm to about 1 μm and the gap being about 5 nm to about 100 nm.

8. The nanosheet of any one of claims 1 to 7, wherein the support comprises silica, an insulating material, a polymer, a metal, a metal oxide, or a semiconductor.

9. The nanosheet of any one of claims 1 to 8, wherein the support has a thickness of about 5 to about 100 nm.

10. The nanosheet of any one of claims 1 to 9, having a density of SERS-active nanostructures of about 5 nanostructures/μm² to about 200 nanostructures/μm².

11. The nanosheet of any one of claims 1 to 10, wherein the SERS-active nanostructures comprise gold, copper, silver, or a combination thereof.

12. The nanosheet of any one of claims 1 to 11, further comprising a dye.

13. The nanosheet of any one of claims 1 to 12, further comprising a SERS-active compound.

14. The nanosheet of claim 13, wherein the SERS-active compound is one or more of 4-methoxythiophenol, 4-bromothiophenol, 3-chlorothiophenol, 4-methylthiophenol, 3-methoxythiophenol, 4-aminothiopenol (APT), and 1,4-benzenedithiol (1-4,BDT).

15. The nanosheet of any one of claims 1 to 14, affixed to a substrate.

16. The nanosheet of claim 15, wherein the substrate is planar.

17. The nanosheet of claim 15, wherein the substrate is non-planar.

18. The nanosheet of claim 17, wherein the substrate is spherical, wavy, irregular, conical, corrugated, fibrous, rough, or porous.

19. The nanosheet of any one of claims 15 to 18, wherein the substrate is a silica sphere, a silicon wafer, a plurality of cells, or a currency note.

20. A method of making the nanosheet of any one of claims 1 to 19, comprising
(a) dispersing at least two SERS-active nanostructures on an arbitrary support to form a dispersed SERS-active nanostructure assembly;
(b) introducing a support onto the dispersed SERS-active assembly to form an intermediate assembly, wherein the support is different from the arbitrary support;
(c) removing the arbitrary support from the intermediate assembly; and
(d) removing the sacrificial metal segment to form the gap.

21. The method of claim 20, wherein the dispersing of step (a) comprises dispersing the at least two SERS-active nanostructures in a solvent to form a SERS-active nanostructure dispersion and filtering the dispersion onto the arbitrary support.

22. The method of claim 21, wherein the filtering comprises vacuum filtration.

23. The method of claim 20, wherein the dispersing of step (a) comprises patterning the arbitrary support with a binding affinity material compatible with the at least two SERS-active nanostructures using lithography or transfer printing.

24. A method of detecting an SERS-active compound in a sample comprising
(a) contacting the sample with the nanosheet of any one of claims 1 to 19;
(b) irradiating the nanosheet; and
(c) detecting for the presence of a SERS signal, wherein the presence of the SERS signal indicates the presence of the SERS-active compound.

25. The method of claim 24, wherein the SERS-active compound is cocaine, heroin, methadone, codeine, tetrahydrocannabinol (THC), or methamphetamine.

26. A method of confirming the authenticity of a good comprising
(a) affixing the nanosheet of any one of claims 1 to 19 to a genuine good to identify the genuine good; and
(b) analyzing the good for a SERS signal from the nanosheet,
wherein the absence of the SERS signal indicates that the good is counterfeit.

27. The method of claim 26, wherein the good is a currency note, a product label, a product package, or a product package insert.
